(19) United States
(12) Patent Application Publication
(10) Pub. No.: US 2007/0259713 A1
(43) Pub. Date: Nov. 8, 2007

(54) Wagering Game with Character Building

(75) Inventors: Daniel P. Fiden, Chicago, IL (US); Lisa M. Helfer, Chicago, IL (US); Matthew J. Ward, Northbrook, IL (US)

Correspondence Address: NIXON PEABODY LLP, 161 N. CLARK STREET, 48TH FLOOR, CHICAGO, IL, 60601-3213, US

(73) Assignee: WMS Gaming, Inc., Waukegan, IL (US)

(21) Appl. No.: 11/630,455

(22) PCT Filed: Jun. 30, 2005
(86) PCT No.: PCT/US05/23097

§ 371 Date: Dec. 20, 2006

Related U.S. Application Data
(60) Provisional application No. 60/584,685, filed on Jun. 30, 2004.

(51) Int. Cl. A63F 13/00

(52) U.S. Cl. 463/25

(57) ABSTRACT

Method and system are disclosed for operating a wagering game terminal where unused game assets accrued by players in one game are restored to them in a subsequent game. The method and system of the invention involves awarding game assets to the players as they progress through a game. The players may be represented by characters or avatars in each game, and the accrued game assets are then added to the inventory of the avatars. The game assets may or may not be usable in the current game or even in the current gaming session. In the latter case, the game assets are returned to player characters or avatars in a subsequent game or a gaming session. This allows the players to retain the benefits of their game assets should they decide not to use them or are unable to use them in the current game or gaming session.

### FIELD OF THE INVENTION

The present invention relates generally to wagering game terminals and, more particularly, to a method and system of operating a wagering game terminal where player characters or avatars may accumulate and retain their game assets in between games.

### BACKGROUND OF THE INVENTION

Wagering game terminals, such as slot machines, video poker machines, and the like, have been a cornerstone of the gaming industry for several years. The popularity of such wagering game terminals among players generally depends on the perceived likelihood of winning money at the terminal and the intrinsic entertainment value of the terminal relative to other available gaming options. Where the available gaming options include a number of competing terminals and the expectation of winning each terminal is roughly the same (or believed to be the same), players are likely to be attracted to the more entertaining and exciting of the terminals.

Consequently, wagering game terminal operators strive to employ the most entertaining and exciting terminals available because such terminals attract frequent play and, hence, increase profitability for the operators. Thus, in the highly competitive wagering game terminal industry, there is a continuing need to develop new types of games, or improvements to existing games, that will enhance the entertainment value and excitement associated with the games.

One concept that has been successfully employed in existing wagering game terminals to enhance player entertainment is the use of progressive games. In the gaming industry, a “progressive” game involves collecting coin-in data from participating gaming device(s) (e.g., slot machines), contributing a percentage of that coin-in data to a progressive jackpot amount, and awarding that jackpot amount to a player upon the occurrence of a certain jackpot-won event. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

Another concept that has been employed is that of a secondary or “bonus” game which may be played in conjunction with a “basic” game. The bonus game may include any type of game, either similar to or entirely different from the basic game, and is initiated by the occurrence of certain pre-selected events or outcomes of the basic game. Such a bonus game has been found to produce a significantly higher level of player excitement than the basic game alone because it provides an additional chance to play, which increases the player's overall expectation of winning.

In current wagering game terminals, whether in a basic game, bonus game, or progressive game, once a player leaves the game, there is little incentive for the player to return to the game at a later time. Typically, upon termination of play, the player is immediately awarded the balance of any credits, but also loses any unused or unredeemed game assets that he may have accumulated. For example, some bonus games involve the player collecting game assets until a certain number or combination of assets is accumulated, at which point the player wins an award. However, if the player leaves the game prior to winning the award, he loses all of his game assets and is forced to start from the beginning the next time he plays. Thus, with all of his game assets gone, there is little incentive for the player to return to the game at a latter time.

Thus, there is a need for wagering game terminals that allow players who accumulate assets in a game to have those game assets restored to them when the players return to the game at a later time.

### SUMMARY OF THE INVENTION

The present invention is directed to a method and system for operating a wagering game terminal where unused or unredeemed game assets accrued by players in one game are restored to them in a subsequent game. The method and system of the invention involves awarding game assets to the players as they progress through a game. The players may be represented by characters or avatars in each game, and the accrued game assets are then added to the inventory of the characters or avatars. The game assets may or may not be usable in the current game or even in the current gaming session. In the latter case, the assets are returned to player characters or avatars in a subsequent game or a subsequent gaming session. Such an arrangement allows the players to retain the benefits of their game assets should they decide not to use them or are unable to use them in the current game or gaming session.

In general, in one aspect, the invention is directed to a wagering game terminal. The wagering game terminal comprises a wager input for accepting a wager from a player at the wagering game terminal, the wager initiating a gaming session. The wagering game terminal further comprises a display for displaying an avatar representing the player in the current gaming session, the avatar possessing one or more game assets accrued by the player during the current gaming session. The wagering game terminal is configured to save the avatar upon conclusion of a current gaming session, including the one or more game assets possessed by the avatar, and to restore the avatar in a subsequent gaming session along with the one or more game assets possessed by the avatar.

In general, in another aspect, the invention is directed to a method of operating a wagering game terminal. The method comprises accepting a wager input from a player at the wagering game, the wager input initiating a current gaming session, and displaying an avatar representing the player in the current gaming session, the avatar possessing one or more game assets accrued by the player during the current gaming session. The method further comprises saving the avatar upon conclusion of the current gaming session, including the one or more game assets possessed by the avatar, and restoring the avatar in a subsequent gaming session along with the one or more game assets possessed by the avatar.

In general, in still another aspect, the invention is directed to a wagering game system. The wagering game system comprises a network server and a wagering game terminal connected to the network server for playing a game in which a player-selected avatar may accrue game assets. The network server is configured to save information regarding the player-selected avatar and the game assets accrued by the player-selected avatar upon conclusion of a current game and to restore the player-selected avatar and the game assets accrued by the player-selected avatar in a subsequent game.

In general, in yet another aspect, the invention is directed to a method of operating a wagering game terminal. The method comprises the steps of presenting a player of a current game with a plurality of game options, each game option having a randomly assigned game asset and allowing the player to select at least one game option from the plurality of game options. The method further comprises the steps of awarding the randomly assigned game asset to an avatar representing the player in the current game upon selection of a respective game option and storing information regarding the game asset when the player leaves the current game. The game asset is then made available to the player in a subsequent game.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 illustrates a wagering game terminal having retainable game assets according to one embodiment of the present invention;

FIG. 2 illustrates the wagering game terminal of FIG. 1 in more detail;

FIG. 3 illustrates a network to which the wagering game terminal of FIG. 1 may be connected;

FIG. 4 illustrates a plurality of game options for an exemplary game according to one embodiment of the present invention;

FIG. 5 illustrates exemplary game assets that may be accrued according to one embodiment of the present invention;

FIG. 6 illustrates a randomly selected outcome resulting in a subsequent exemplary game that may be played according to one embodiment of the present invention;

FIG. 7 illustrates an avatar selection screen for the subsequent exemplary game according to one embodiment of the present invention;

FIG. 8 illustrates a plurality of game options for the subsequent exemplary game according to one embodiment of the present invention; and

FIG. 9 illustrates an exemplary game asset that may be accrued in the subsequent exemplary game according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

As mentioned above, embodiments of the invention provide a method and system for operating a wagering game terminal where players, through their characters or avatars, may retain any game assets that they may have accrued. Such an arrangement allows games assets that may not be immediately useful in the current gaming session to be saved and subsequently used in a later gaming session.

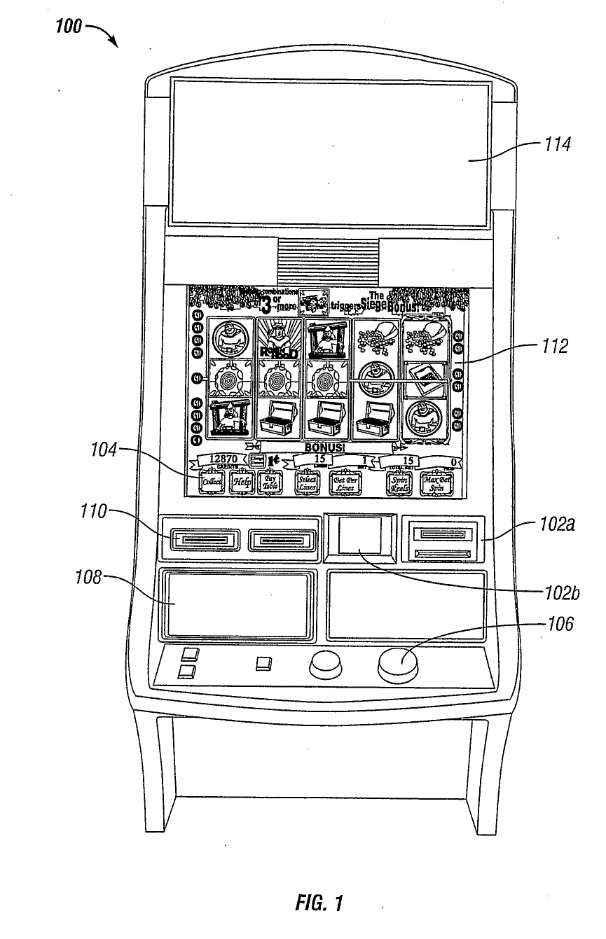

FIG. 1 shows a perspective view of an exemplary wagering game terminal 100 according to embodiments of the invention. The wagering game terminal 100 may be operated as a stand-alone terminal, or it may be connected to a network of wagering game terminals. Further, the wagering game terminal 100 may be any type of wagering game terminal and may have varying structures and methods of operation. For example, the wagering game terminal 100 may be a mechanical wagering game terminal configured to play mechanical slots, or it may be an electromechanical or electrical wagering game terminal configured to play a video casino game, such as blackjack, slots, keno, poker, etc. In the example shown, the wagering game terminal 100 is a video slot machine.

As shown, the wagering game terminal 100 includes input devices, such as a wager acceptor 102 (shown as a card wager acceptor 102a and a cash wager accepter 102b), a touch screen 104, a push-button panel 106, a payout mechanism 108, and an information reader 110. The wagering game terminal 100 further includes a main display 112 for displaying information about the basic wagering game and, in some embodiments, a secondary display 114 for displaying a pay table and/or game-related information or other entertainment features. While these typical components found in the wagering game terminal 100 are described briefly below, it should be understood that numerous other elements may exist and may be used in any number of combinations to create variation of the wagering game terminal 100.

The wager acceptors 102a and 102b may be provided in many forms, individually or in combination. For example, the cash wager acceptor 102a may include a coin slot acceptor or a note acceptor to input value to the wagering game terminal 100. The card wager acceptor 102b may include a card-reading device for reading a card that has a recorded monetary value with which it is associated. The card wager acceptor 102b may also receive a card that authorizes access to a central account that can transfer money to the wagering game terminal 100.

The payout mechanism 108 performs the reverse function of the wager acceptors 102a and 102b. For example, the payout mechanism 108 may include a coin dispenser or a note dispenser to dispense money or tokens from the wagering game terminal 100. The payout mechanism 108 may also be adapted to receive a card that authorizes the wagering game terminal 100 to transfer credits from the wagering game terminal 100 to a central account.

The push button panel 106 is typically offered, in addition to the touch screen 104, to provide players with an option on making their game selections. Alternatively, the push button panel 106 may facilitate player input needed for certain aspects of operating the game, while the touch screen 104 facilitates player input needed for other aspects of operating the game.

The outcome of the basic wagering game is displayed to the player on the main display 112. The main display 112 may take a variety of forms, including a cathode ray tube (CRT), a high resolution LCD, a plasma display, LED, or any other type of video display suitable for use in the wagering game terminal 100. As shown here, the main display 112 also includes the touch screen 104 overlaying the entire display (or a portion thereof) to allow players to make game-related selections. Alternatively, the wagering game terminal 100 may include a number of mechanical reels that display the game outcome.

In some embodiments, the information reader 110 is a card reader that allows for identification of a player by reading a card with information indicating they player's identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 110, which allows the casino's computers to register that player's wagering at the wagering game terminal 100. Then, the wagering game terminal 100 may use the secondary display 114 for providing the player with information about his or her account or other player-specific information. Also, in some embodiments, the information reader 110 may be used to restore assets that the player achieved during a previous gaming session and had saved.

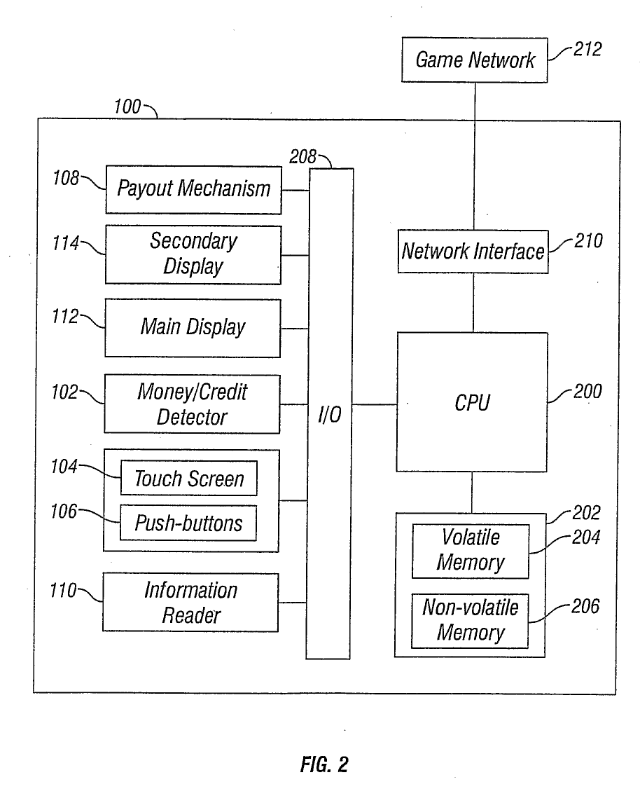

As shown in FIG. 2, the various components of the wagering game terminal 100 are controlled by a central processing unit (CPU) 200, such as one or more microprocessors or microcontrollers. To provide the gaming functions, the CPU 200 executes a game program that generates a randomly selected game outcome. The CPU 200 is also coupled to or includes a local memory 202. The local memory 202 may be in the form of one or more volatile memories 204 (e.g., a random-access memory (RAM)) and one or more non-volatile memories 206 (e.g., an EEPROM).

Communication between the peripheral components of the wagering game terminal 100 and the CPU 200 is controlled by the CPU 200 through input/output (I/O) circuits 208. The CPU 200 also communicates with external systems via a network interface unit 210. Although the I/O circuit 208 and network interface unit 210 are shown here as individual components, it should be appreciated that both of these units may include a number of different types of components.

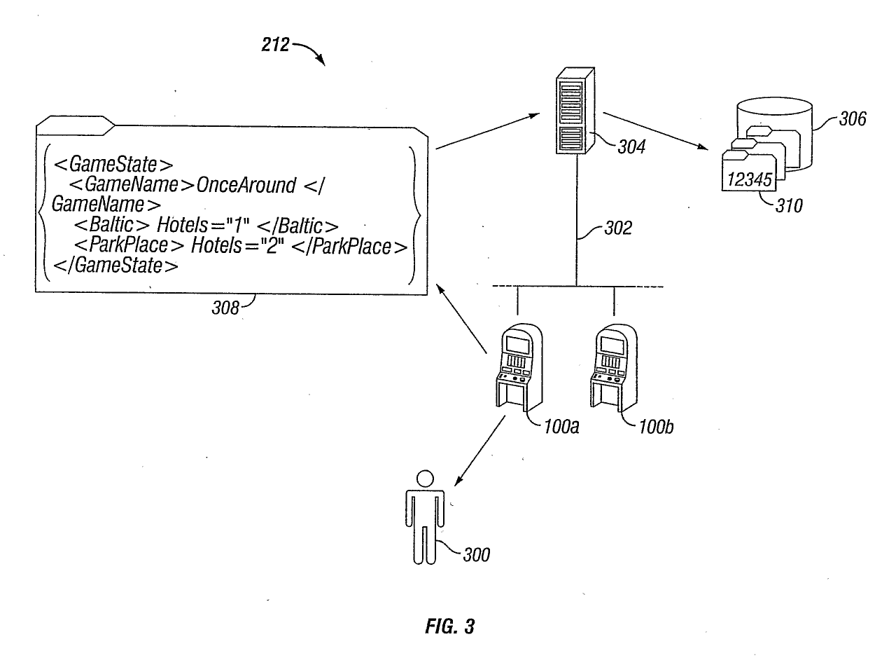

As alluded to above, the wagering game terminal 100 may be a stand-alone terminal, or it may be part of a network 212 that connects multiple wagering game terminals 100 together. FIG. 3 illustrates the network 212 in more detail, including a plurality of wagering game terminals 100a and 100b connected via an Ethernet-TCP/IP connection 302 to a network server 304. The wagering game terminals 100a and 100b are similar to the wagering game terminal 100 (FIG. 1) in that they have many of the same features and components. In addition, one or more functions of the CPU 200 (FIG. 2) in the terminals 100a and 100b may reside on the network server 304 instead of, or in addition to, the wagering game terminal 100. The network server 304 may then conduct the basic and/or bonus games (or portions thereof) in place of the CPU 200 for each of the wagering game terminals 100a and 100b connected to the network 212, including providing the input data and information needed to operate the basic and/or bonus games.

The network server 304 may also control the progressive jackpots mentioned previously that are contributed to by all or some of the wagering game terminals 100a and 100b in the network 212 (e.g., terminal-level jackpots that only each terminal 100a or 100b contributes to, bank-level jackpots that are contributed to by all of the terminals 100a and 100b in a particular bank, and wide-area jackpots that are contributed to by a larger number of terminals 100a and 100b, such as multiple banks).

In addition, in accordance with embodiments of the invention, the network 212 allows players playing at one of the wagering game terminals 100a or 100b to store game assets that they may have accumulated for subsequent retrieval at a later time. The game assets may be any aspect of a basic and/or bonus game, whether tangible or intangible, that a player may win or accumulate, including, but not limited to, monetary or non-monetary awards, features or characteristics of a game (e.g., a wild symbol, free spins), features or characteristics of a player (e.g., extra lives, intelligence, skills, equipment), a bonus game, and the like. By allowing the players to retain their game assets when they cash out, the players are given much incentive to return to the wagering game terminals 100a and 100b at a later time.

In some embodiments, the game assets, including any bonus games, may be retained through a “ticket-in-ticket-out” (TITO) system on the network 212. The TITO system issues each player a ticket when the player departs a wagering game terminal 100a or 100b, which ticket can be used later to retrieve all the assets that the player has accumulated in the current game. Then, when the player returns to any wagering game terminal 100a or 100b on the network 212, he may retrieve his game assets by presenting the ticket. An exemplary implementation of a TITO system is described below.

Referring still to FIG. 3, when a player 300 is ready to cash out of any wagering game terminal 100a or 100b on the network 212, the player 300 may request a ticket for his current game. Upon receiving such as request, the wagering game terminal 100a or 100b generates a game-specific file 308, which may be a text file, XML file, or other suitable format, that identifies the current wagering game terminal, the current game, the game assets that have been accumulated in the current game, and the like. The game-specific file 308 is then forwarded over the Ethernet-TCP/IP connection 302 to the server 304. The server 304 thereafter creates a game record 310 for the game-specific file 308 in a database 306 connected to, or residing within, the server 304 and generates a unique identifier for the game record 310. The unique identifier preferably is independent of the player's identification such that the player may remain anonymous to the network 212 and the wagering game terminal 100a or 100b, but it is also possible to use an identity-based identifier. The server 304 then sends the unique identifier back to the wagering game terminal 100a or 100b. The wagering game terminal 100a or 100b subsequently issues the player 300 a ticket, which may be a paper ticket or an electronic ticket, containing the unique identifier (e.g., in barcodes). The ticket may be issued through the information reader 110 or any other suitable means commonly used for issuing such tickets.

When the player 300 returns to one of the wagering game terminals 100a or 100b, he may present his ticket to the information reader 110 to retrieve his accumulated assets. The wagering game terminal 100a or 100b may be any wagering game terminal on the network 212 and does not have to be the same wagering game terminal that the player 300 played on previously. Upon receiving the ticket, the wagering game terminal 100a or 100b sends a request to the server 304 to retrieve the game record 310 that corresponds to the unique identifier of the ticket presented. If the server 304 determines that the ticket is valid (i.e., the unique identifier matches an unclaimed game record 310), it retrieves the corresponding game record 310 and sends the information contained therein back to the wagering game terminal 100a or 100b. The server 304 thereafter either deletes the game record 310 or marks it as “claimed” so that it is not reused. The terminal 100a or 100b then configures itself according to the game asset information received from the server 304 such that the player retains all of his game assets.

In embodiments where the wagering game terminal 100a or 100b is a stand-alone terminal that is not connected to the network 212, the game record 310 may be created by the CPU 200 (FIG. 2) and stored in the local memory 202 of the wagering game terminal instead of on the network. Then, when the player 300 returns to the same stand-alone wagering game terminal to present his ticket (e.g., via the information reader 110), the appropriate game record 310 may be retrieved based on the unique identifier on the ticket. The CPU 200 thereafter restores the player's game assets along with any other information (e.g., wagering game terminal, game, etc.) that was stored in the game record 310. This allows the player to keep his game assets even after a particular gaming session ends, thereby increasing player commitment to a game.

In some embodiments, instead of a ticket, the information reader 110 may include a card reader, and the unique identifier provided by the wagering game terminal 100a or 100b may be stored on a player's personal identification card. Or, the wagering game terminal 100a or 100b may include a radio frequency identification device (RFID) transceiver or receiver (not shown) such that an RFID transponder held by the player can be used to provide the unique identifier at the wagering game terminal 100a or 100b without the need to insert a card into the information reader 110. RFID components can be those available from Pacific Northwest National Laboratory (under the United States Department of Energy) of Richland, Wash.

In other embodiments, the information reader 110 may also include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, NY. Other biometric identification techniques can be used as well for providing a unique identifier of the player. For example, a microphone can be used in a biometric identification device on the wagering game terminal so that the player can be recognized using a voice recognition system.

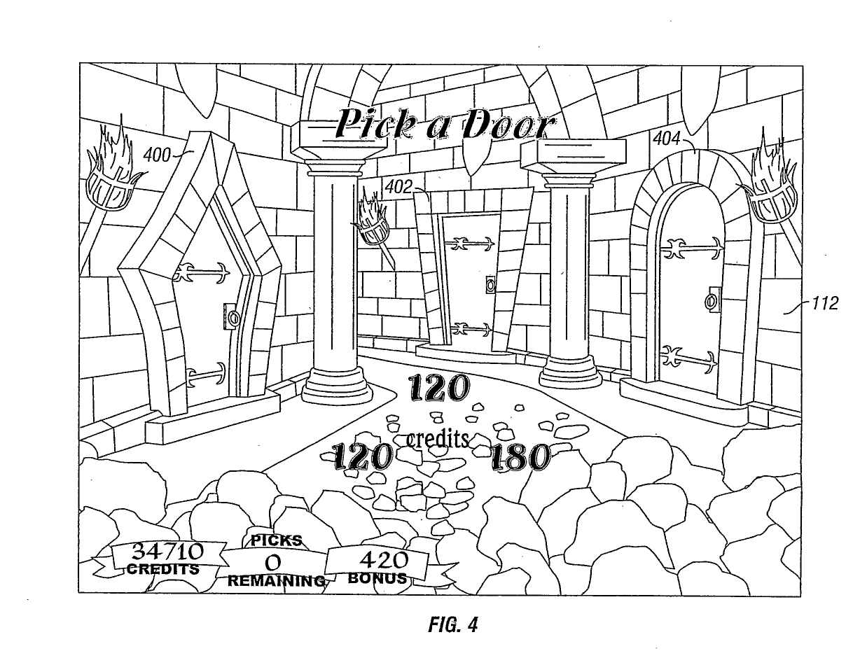

An exemplary game played on the wagering game terminal 100a or 100b and having game-asset retention capability according to embodiments of the invention will now be described with respect to FIGS. 4-9. The exemplary game may be played as a basic game or a bonus game, and may include any type of game where a player may accumulate game assets. As can be seen in FIG. 4, the exemplary game described here is a bonus game that the player Won as a result of his basic game. The bonus game is a role-playing type game where the player tries to build up his or her chosen character or avatar by collecting game assets. In one version of the game, the player is presented with the option of selecting one of three doors 400, 402, and 404 (as displayed on the main display 112). Behind each door 400, 402, or 404 is a randomly assigned game asset (e.g., number of credits) that the player wins upon opening the door. Each time a game asset is added to (or removed from) a character or avatar, the appearance of the character or avatar may be altered somewhat to reflect the change. For example, the character or avatar may appear larger, have more weapons, have a bigger number on his chest, and so forth.

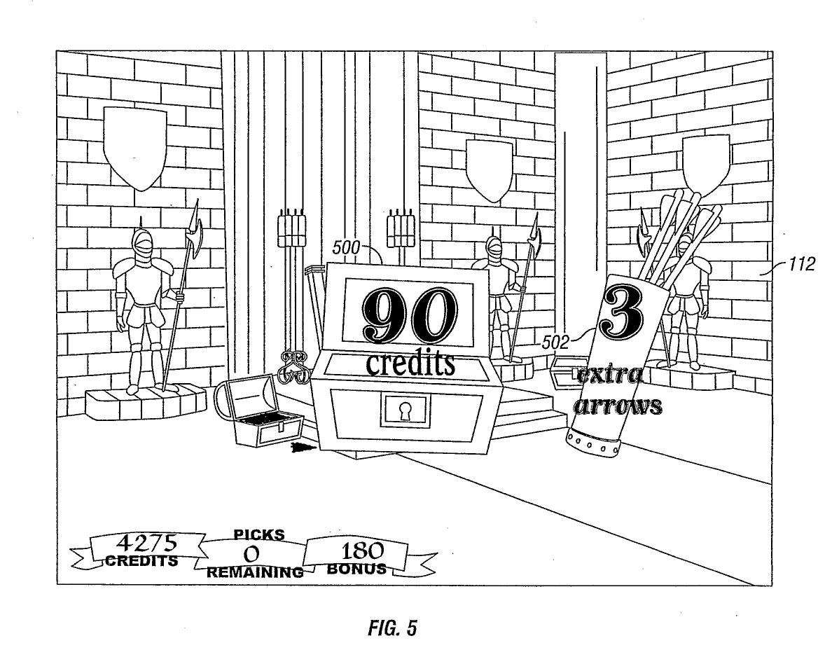

In addition to credits, or instead of same, the player may win other, more tangible game assets, such as tools or equipment. FIG. 5 shows an example where the player has selected a door behind which 90 credits (indicated at 500) along with three extra arrows 502 are present. The equipment may be useful in the present game, or it may have no use whatsoever in the present game. In the latter case, in accordance with embodiments of the invention, the player's character or avatar is allowed to retain the equipment for possible use in a subsequent game. The player may or may not be told (or given hints) during the game that the equipment is not useful in the present game and that he should hold on to them for possible use in a subsequent game. The subsequent game where the equipment is useful, however, may or may not occur in the current gaming session, so the player may have to save his game assets (e.g., via a ticket) until the next gaming session before he can use the equipment.

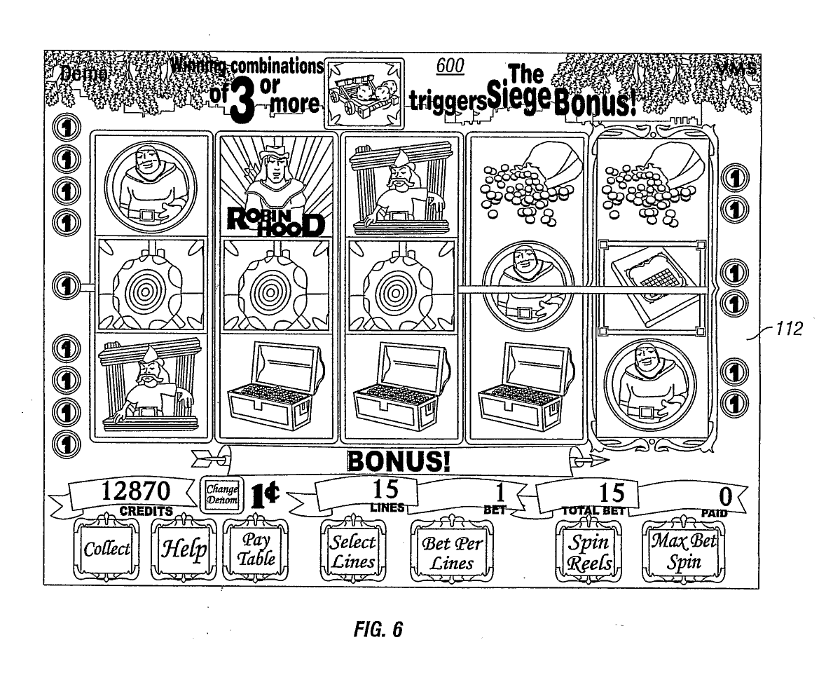

In the example shown here, the arrows 502, while building up the player's character or avatar, have no utility in the current game and the player has to wait for a subsequent game in order to use the arrows. This is illustrated in FIG. 6, where the player has won another bonus game by lining up three target symbols in his basic game. The new bonus game may arise in either the current gaming session or in a subsequent gaming session (when the player's saved game assets have been restored).

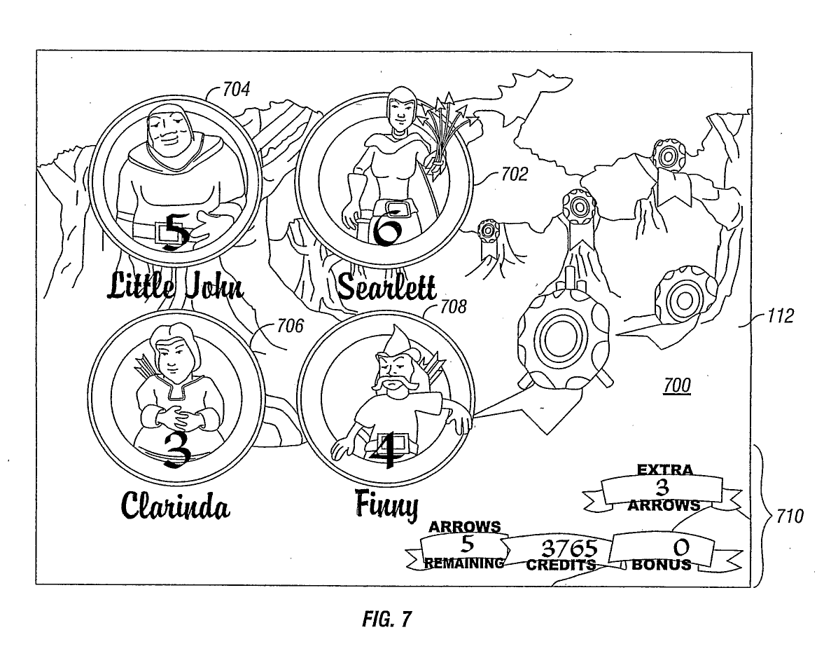

Upon winning the bonus game, the player is shown a character selection screen 700, depicted in FIG. 7, from which he may select one of several avatars 702, 704, 706, and 708 to use. One or more of the avatars 702, 704, 706, and 708 may have already accrued certain game assets, but the player does not know what game assets have been acquired by which avatar until one is selected, after which the character selection screen 700 reveals-the equipment status (e.g., number of arrows) for all the avatars. An information area 710 displays the current game information, including the equipment status of the selected avatar. Whichever avatar is selected, the player's game assets are transferred to that avatar, regardless of the point in time when the avatar is selected (e.g., in a subsequent gaming session). In the example shown here, the player has selected an avatar 702 with six arrows, thus giving him nine total arrows (counting the three extra arrows previously won) that may be used.

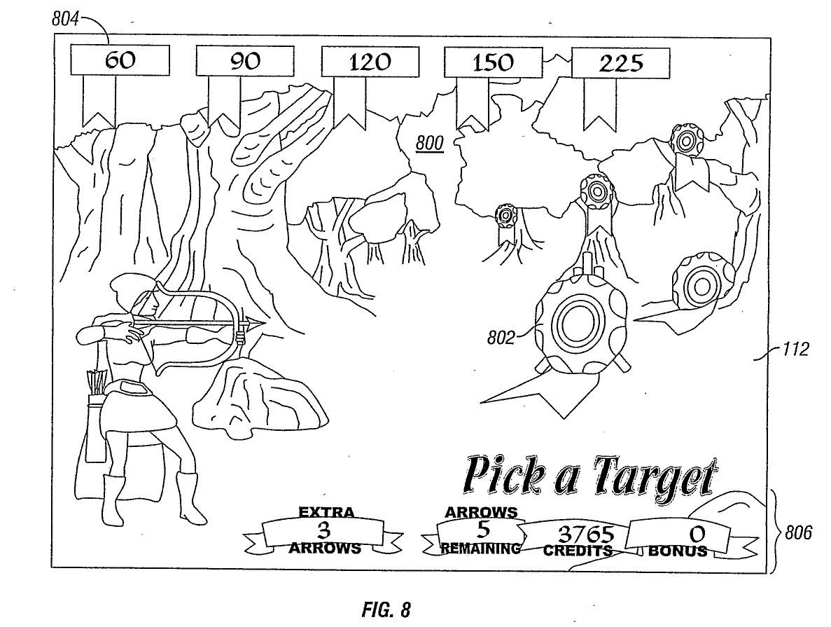

As the player proceeds through the bonus game, he may eventually come to a target screen 800, shown in FIG. 8, where the arrows may be used. The target screen 800 may include a number of targets 802 to which a preselected prize/number of credits (indicated at 804) may be randomly assigned. By hitting one or more of the targets 802 with his arrows, the player can win the prizes/credits that are assigned to those targets. Different prizes/number of credits may also be won by hitting different parts of the target. In some embodiments, it is also possible to miss the target entirely, in which case no prizes/credits are won. An information area 806 shows the changes in the player's game assets based on any target 802 that he may hit.

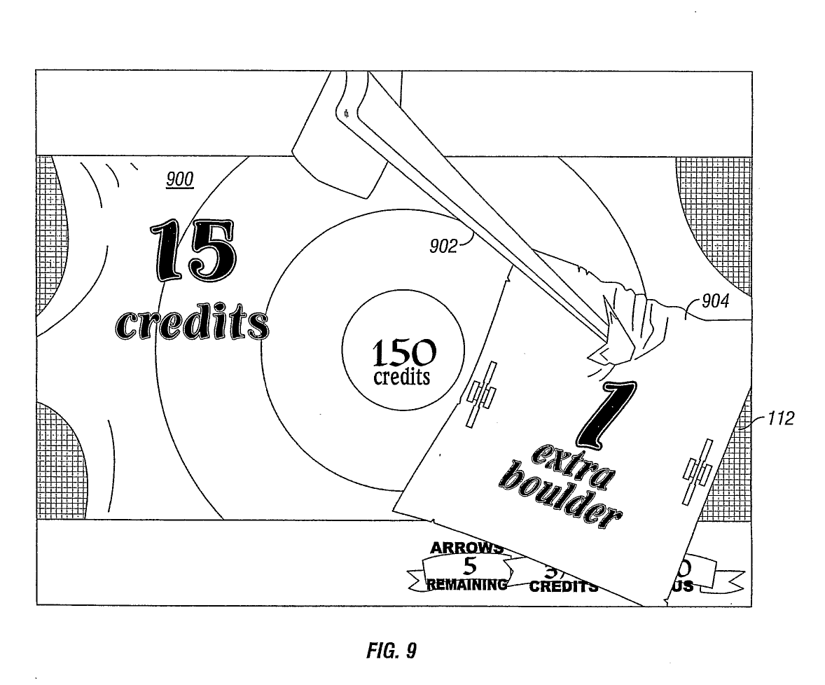

FIG. 9 is a close-up view 900 showing one of the targets hit by the player. This particular target is worth 150 credits and also adds an extra boulder to the player's game assets, as indicated by the arrow 902 piercing the boulder notification flyer 904. In accordance with embodiments of the invention, the extra boulder may or may not be useful in the current game or gaming session, and the player may have to wait for the next game or gaming session in order to use the boulder.

Although the foregoing embodiments have been described with respect to tangible game assets, it should be clear that many other, intangible assets may also be acquired. For example, in some embodiments, the game assets may be in the form of access to more features and higher levels where the more a player plays (in terms of time spent or games played), the more he is eligible for additional prizes, games, or higher planes within a game. This may be manifested, for example, by the avatar's image growing larger and, hence, more physically able to open/reach new features/bonus rounds.

Other game assets may include traits, such as intelligence, endurance, healing, strength, increased success percentage, speed, agility, extra lives, and the like. In some games, the avatar may be shown as gradually growing from a child to an adult with increased game play. In some games, the avatar may be endowed with the ability to fly and other similar “superpowers,” or may have increased monetary earnings or be given promotions. Where appropriate, the avatar may have a personal adviser who becomes more knowledgeable and capable as the player increases his play.

Where the game assets do involve tangible objects, the objects may be part of a theme, such as “Indiana Jones” where the player's avatar may accrue whips, ropes, knives, and the like. The avatar may become more skilled with these objects as the player increases his play. Other themed games may include a “Star Trek” game where the Starship Enterprise may be used as an avatar. As the player increases his play, the ship may be endowed with more powerful phasers, more photon torpedoes, faster warp drive, self-repair capability, and so on.

And while the discussion thus far has centered around bonus games triggering the character building, character building can also be triggered by other events besides bonus games. For example, certain reel events, such as obtaining a certain symbol, collecting a certain number of symbols, achieving certain goals, and so forth, may also be used to trigger character building.

Finally, although the restored game assets are not avatar-specific (i.e., any avatar may receive the game assets) in the above examples, in some embodiments, the game assets can only be restored to the avatar that originally acquired the game assets. In these avatar-specific embodiments, the player will need to select the same avatar that was used previously if he wants to carry forward his game assets. Further, these avatars may be given only a limited amount of time to use their game assets (e.g., three gaming sessions), after which the avatar's equipment status will be reset. Alternatively, the avatars may retain their game assets until the goal of the game is achieved, for example, by reaching the grand prize. Where the game does not have a definite goal, but simply keeps evolving and progressing, the avatar may retain his game assets indefinitely.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A wagering game terminal, comprising:
a wager input for accepting a wager from a player at said wagering game terminal, said wager initiating a gaming session; and
a display for displaying an avatar representing said player in said current gaming session, said avatar possessing one or more game assets accrued by said player during said current gaming session;
wherein said wagering game terminal is configured to save said avatar upon conclusion of a current gaming session, including said one or more game assets possessed by said avatar, and to restore said avatar in a subsequent gaming session along with said one or more game assets possessed by said avatar.

2. The wagering game terminal according to claim 1, wherein said one or more game assets are useable during said current gaming session.

3. The wagering game terminal according to claim 1, wherein said one or more game assets are not useable during said current gaming session.

4. The wagering game terminal according to claim 1 wherein said one or more game assets include tangible game assets.

5. The wagering game terminal according to claim 1, wherein said one or more game assets include intangible game assets.

6. The wagering game terminal according to claim 1, wherein said current gaming session includes a basic game and said one or more game assets are accrued in said basic game.

7. The wagering game terminal according to claim 1, wherein said current gaming session includes a bonus game and said one or more game assets are accrued in said bonus game.

8. The wagering game terminal according to claim 1, wherein said subsequent gaming session and said current gaming session form one continuous gaming session.

9. The wagering game terminal according to claim 1, wherein said subsequent gaming session is delayed in time following said current gaming session.

10. The wagering game terminal according to claim 1, wherein said avatar is different for said current gaming session and said subsequent gaming session.

11. A method of operating a wagering game terminal, comprising:
accepting a wager input from a player at said wagering game, said wager input initiating a gaming session;
displaying an avatar representing said player in said current gaming session, said avatar possessing one or more game assets accrued by said player during said current gaming session;
saving said avatar upon conclusion of a current gaming session, including said one or more game assets possessed by said avatar; and
restoring said avatar in a subsequent gaming session along with said one or more game assets possessed by said avatar.

12. The method according to claim 11, further comprising altering an appearance of said avatar to reflect a change in said one or more game assets possessed by said avatar.

13. The method according to claim 11, further comprising allowing said player to select said avatar for both said current gaming session and said subsequent gaming session.

14. The method according to claim 12, wherein said player selects a single avatar for both said current gaming session and said subsequent gaming session.

15. The method according to claim 12, wherein said player selects different avatars for said current gaming session and said subsequent gaming session, further comprising transferring said one or more game assets from an avatar in said current gaming session to an avatar in said subsequent gaming session.

16. A wagering game system, comprising:
a network server; and
a wagering game terminal connected to said network server for playing a current game in which a player-selected avatar may accrue game assets;
wherein said network server is configured to save information regarding said player-selected avatar and said game assets accrued by said player-selected avatar upon conclusion of said current game and to restore said player-selected avatar and said game assets accrued by said player-selected avatar in a subsequent game.

17. The wagering game system according to claim 16, further comprising a storage unit for storing said information regarding said player-selected avatar and said game assets accrued by said player-selected avatar along with an identifier for said information.

18. The wagering game system according to claim 17, wherein said storage unit resides on said network server.

19. The wagering game system according to claim 17, wherein said storage unit resides in said wagering game terminal.

20. The wagering game system according to claim 17, wherein said identifier for said information is player identity-independent.

21. The wagering game system according to claim 17, wherein said identifier for said information is based at least in part on a player identification.

22. A method of operating a wagering game terminal, comprising:
presenting a player of a current game with a plurality of game options, each game option having a randomly assigned game asset;
allowing said player to select at least one game option from said plurality of game options;
awarding said randomly assigned game asset to an avatar representing said player in said current game upon selection of a respective game option;
storing information regarding said game asset when said player leaves said current game; and
making said game asset available to said player in a subsequent game.

23. The method according to claim 22, wherein said player is represented by another avatar in said subsequent game, further comprising endowing said other avatar with said game assets awarded in said current game.
